(19) United States
(12) Patent Application Publication
(10) Pub. No.: US 2007/0139589 A1
(43) Pub. Date: Jun. 21, 2007

(54) Transflective liquid crystal displays with patterned optical layer

(75) Inventors: Sander Jurgen Roosendaal, Eindhoven (NL); Emiel Peeters, Eindhoven (NL); Johan Lub, Eindhoven (NL); Bianca Maria Irma Van Der Zande, Eindhoven (NL); Ciska Doornkamp, Eindhoven (NL); Dirk Kornelis Gerhardus De Boer, Eindhoven (NL); Jacob Bruinink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,189

(22) PCT Filed: Feb. 23, 2005
(86) PCT No.: PCT/IB05/50661

§ 371 Date: Aug. 21, 2006

(30) Foreign Application Priority Data
Feb. 26, 2004 (EP) 04100766.7

(51) Int. Cl. G02F 1/1335

(52) U.S. Cl. 349/114

(57) ABSTRACT

A transflective liquid crystal display comprising a plurality of pixels, each pixel comprising a liquid crystal layer (3) sandwiched between a front substrate (1) and a back substrate (2), and an optical layer (7) comprising a birefringent material, said pixels being divided into at least one transmissive (5) and at least one reflective subpixel (4), and said optical layer (7) being at least partly sandwiched between the liquid crystal layer (3) and one of said front substrate (1) or back substrate (2), and being patterned into domains (8, 9), each domain covering at least part of a reflective subpixel (4) or at least part of a transmissive subpixel (5).

### FIELD OF THE INVENTION

The present invention relates to transflective liquid crystal displays with improved viewing angle dependence and contrast, especially to patterned optical layers for improving the viewing angle dependence and the contrast of said display. The invention also relates to methods for the manufacture of such displays.

### TECHNICAL BACKGROUND

Liquid crystal displays (LCDs) are used in a wide range of applications, such as in television sets, computer monitors and handheld and automotive devices. The operation of LCDs is based on light modulation in a liquid crystalline cell (LC-cell), which cell is constructed of a liquid crystalline layer sandwiched between a front substrate and a rear substrate.

LCDs are generally operated in one or both of two modes, namely a transmissive mode and a reflective mode. In a transmissive LCD, light originating from a backlight is modulated by the LC-layer. Due to the backlight, transmissive LCDs are suited for use in dark environments, such as indoor use. One inherent drawback of a transmissive LCD is the viewing angle dependency of the optical characteristics. Especially at oblique viewing angles, the displayed image has a reduced contrast and suffers from gray scale inversion. Also, transmissive LCDs becomes practically unreadable in environments with bright ambient light, making the display hard to use under, e.g. direct sunlight.

In a reflective LCD, ambient light is modulated by the LC-layer and reflected back towards the viewer. This type of LCDs are suited for outdoor use, with bright ambient light, such as sunlight. Inherent drawbacks of reflective LCDs are limited brightness and contrast.

A so called transflective LCD is, as the name suggests, a combination of a transmissive and a reflective LCD. In most transflective LCDs, each pixel is divided into a transmissive part of the pixel (transmissive subpixel) and a reflective part of the pixel (reflective subpixel). This makes the display useable both in bright conditions, by virtue of the reflective part of the display, and in dark conditions, by virtue of the transmissive display.

Prior art transflective LCDs suffer from a viewing angle dependence. When viewed from oblique angles, the picture on the display suffers from low contrast and gray scale inversion. This is due to the birefringence in the LC-material in the LC-layer. This birefringence introduces an ellipticity to the light that leaves the LC-layer, and this ellipticity impairs the function of the front polarizers, especially for light passing through the polarizers at oblique angles.

WO 03/019276 discloses the interposition of a λ/4 (quarterwave) retarder between the LC-layer and the front substrate in order to improve the contrast ratio for the reflective part of a transflective LCD. However, the transmissive part of the transflective LCD still suffers from a limited viewing angle.

One way of improving (reducing) the viewing angle dependence for a transmissive LCD is to interpose a viewing angle compensation layer between the liquid crystal cell and the front polariser and/or between the liquid crystal cell and the back polariser. A viewing angle compensation layer comprises a birefringent material that compensates for the birefringence in the liquid crystal cell, thus improving the viewing angle dependence for the transmissive LCD.

However, applying a compensation layer for viewing angle improvement is not straightforward. Care has to be taken to ensure that the compensation layer does not reduce the front of screen performance of the reflective mode.

A collimated backlight combined with a Front Scattering Film (FSF) could also be used to improve the viewing angle. However, this leads to reduced contrast and image sharpness (blur) and is not preferred.

### SUMMARY OF THE INVENTION

One object of the present invention is to provide a transflective LCD which overcomes the problems of viewing angle dependence of the prior art transflective LCDs.

This is obtained by providing a transflective liquid crystal display comprising a plurality of pixels, each pixel comprising a liquid crystal layer sandwiched between a front substrate and a back substrate, an optical layer comprising a birefringent material, said pixels being divided into at least one transmissive and at least one reflective subpixel, and said optical layer being at least partly sandwiched between the liquid crystal layer and a substrate, and being patterned into domains, each domain covering at least part of a reflective subpixel or at least part of a transmissive subpixel, wherein the birefringence of said birefringent material in a domain covering a reflective subpixel of a pixel is different from the birefringence of said birefringent material in the domain(s) covering the transmissive subpixel(s) of said pixel, and wherein the birefringence of the domains covering reflective subpixels and the domains covering transmissive subpixels independently are adapted to improve the viewing angle dependence for the reflective and transmissive subpixels respectively covered by said domains.

In preferred embodiments, the tilt, orientation, cholesteric pitch and/or the retardation of the birefringent material in domains covering reflective subpixels is different from the tilt, orientation, cholesteric pitch and/or retardation of the birefringent material in domains covering transmissive subpixels.

The present invention also relates to methods for the manufacture of transflective liquid crystal displays comprising such optical layers. Such methods comprise the steps of providing a substrate, optionally provided with an alignment film, providing a polymerisable mixture comprising liquid crystal molecules, aligning said liquid crystal molecules uniaxially or patterned on said substrate, performing a first irradiation using UV-light, e-beam or other sources of radiation of the mixture through a mask under a first reaction condition, to polymerize the irradiated polymerisable mixture in a first configuration exhibiting a first birefringence, performing a second irradiation of the mixture under a second reaction condition, to polymerize the non-polymerized irradiated polymerisable mixture in a second configuration exhibiting a second birefringence.

Displays according to the present invention are advantageous since they provide an in-cell optical layer that is thin, light, relatively easy to manufacture and avoids parallax problems, and since the use of such an optical layer provides a liquid crystal display with improved (reduced) viewing angle dependence. Another advantage is that the viewing properties easily can be optimized for the reflective and the transmissive parts of the display independently.

The method according to the present invention allows, for the first time, to manufacture an optical foil, the optical properties of which can be independently optimized for the reflective and transmissive subpixels of a transflective LCD. For example, the method allows manufacturing of an optical foil acting as a quarter wave retarder for the reflective subpixels, while at the same time acting as a viewing angle compensator for the transmissive subpixels.

### BRIEF DESCRIPTION OF THE DRAWINGS

FIG. 1 illustrates a sectional view of a transflective LCD.

FIG. 2 illustrates a first preferred embodiment of a LCD display comprising a patterned optical layer.

FIG. 3 shows a viewing angle plot of the embodiment in FIG. 2.

FIG. 4 illustrates a second preferred embodiment of a LCD comprising a patterned optical layer.

FIG. 5 shows a viewing angle plot of the embodiment in FIG. 4.

FIG. 6 illustrates a third preferred embodiment of a patterned optical layer.

FIG. 7 illustrates a fourth preferred embodiment of LCD comprising a patterned optical layer divided into two sublayers.

FIG. 8 shows a viewing angle plot of the embodiment in FIG. 5, compared to the results from a LCD with non-patterned optical layers.

FIG. 9 illustrates a fifth preferred embodiment of a LCD comprising a patterned optical layer, divided into two sublayers.

FIG. 10 shows a viewing angle plot of the embodiment in FIG. 9, compared to the results from a LCD without the patterned optical layer.

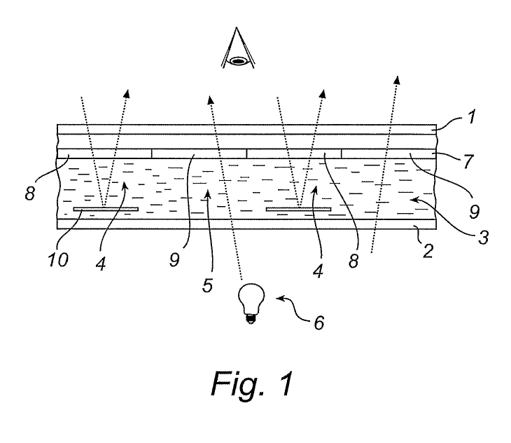

### DETAILED DESCRIPTION OF THE INVENTION

The liquid crystal display (LCD) comprises a front substrate 1 facing the potential user, and a back substrate 2 facing the interior of the display unit.

The LCD also comprises a liquid crystal layer (LC-layer) 3 sandwiched between the substrates.

The liquid crystal layer is divided into a plurality of pixels, wherein each pixel is subdivided into at least one transmissive subpixel 5 and at least one reflective subpixel 4, the subpixels not necessarily having the same area.

A light source 6 is located behind the back substrate 2 and is arranged so that it may send light through the back substrate towards the user. For the reflective subpixels 4, ambient light passes through the front substrate 1 and LC-layer 3 and is in the interior of the display unit reflected towards the user by reflecting means 10.

Such a display wherein each pixel of the display is divided into a reflective and a transmissive part is commonly known as a transflective LCD.

Different types of transflective LCDs, based on different LC-effects, may be used with the present invention. Such different types comprise twisted nematic LCDs, non-twisted LCDs, in-plane switching LCDs and vertically aligned nematic LCDs.

The transflective LCD of the present invention also comprises a patterned optical layer 7 sandwiched between the liquid crystal layer 3 and a substrate 1, 2, preferably between the liquid crystal layer 3 and the front substrate 1, more preferably between the front polarizer when situated inside the cell and the liquid crystal layer 3. The LCD according to the present invention may comprise one optical layer 7 sandwiched between the front substrate 1 and the liquid crystal layer 3 and one optical layer sandwiched between the back substrate and the liquid crystal layer.

Preferably, said optical layer(s) 7 covers essentially the whole area of the liquid crystal layer 3.

An optical layer 7 according to the present invention is patterned into domains 8, 9, wherein each domain covers at least part of one subpixel 4, 5 of the LC-layer. Thus, each domain 8, 9 of the patterned optical layer covers either a transmissive subpixel 5 or a reflective subpixel 4. The optical layer 7 may further be divided into at least two separate sublayers positioned on top of each other. The different sublayers may have different birefringence, and at least one of the sublayers are patterned into domains in the above mentioned manner.

The optical layer 7 comprises a birefringent material, and the material may have a positive or a negative birefringence.

The birefringent material may comprise cholesterically ordered material.

The optical layer 7 preferably comprises a liquid crystalline material. Examples of such liquid crystalline materials comprise discotic liquid crystal molecules and rodlike liquid crystal molecules.

As used herein, discotic liquid crystal molecules refers to liquid crystal molecules comprising a discotic structure unit in its molecule. Discotic liquid crystal molecules generally have negative birefringence. The director of such discotic liquid crystal molecules is parallel to the normal of the plane of the discotic structure. In U.S. Pat. No. 5,583,679, several examples of discotic crystalline materials are disclosed.

The material is more preferably a polymerisable liquid crystalline material, for example rodlike or discotic molecules, containing polymerisable groups.

According to the present invention, the birefringent optical layer is patterned so that the birefringence of the birefringent material in a domain 8 covering a reflective subpixel 4 of a pixel is different from the birefringence of the birefringent material in the domain(s) 9 covering the transmissive subpixel(s) 5 of said pixel.

According to the present invention the optical tilt of the birefringent material may be patterned so that the tilt of the molecules in the birefringent material in a domain 8 covering a reflective subpixel 4 of a pixel is different from the tilt of the molecules in the birefringent material in the domain(s) 9 covering the transmissive subpixel(s) 5 of said pixel.

According to a preferred embodiment of the present invention, the tilt of said birefringent material in the domains either covering transmissive or reflective subpixels increases or decrease with an increase of distance in direction of depth from the surface of the optical layer 7 facing the front substrate 1. The increase/decrease may be stepwise, but is preferably essentially continuous over the direction of depth, and is commonly known as a “splay bend”-deformation. In a splay-bend conformation, the tilt may range from 0° at the surface with the lowest tilt to 90° at the surface with the highest tilt. The surface with the highest tilt may can either be facing away from or towards the interior of the display.

Further according to the present invention, the optical orientation of the birefringent material may be patterned so that the orientation of the molecules in the birefringent material in a domain 8 covering a reflective subpixel 4 of a pixel is different from the orientation of the molecules in the birefringent material in the domain(s) 9 covering the transmissive subpixel(s) 5 of said pixel.

In case the orientation is patterened, the orientation preferably differs approximately 35-55° between a domain 8 covering a reflective subpixel 4 and a domain 9 covering a corresponding transmissive subpixel 5 to obtain minimum unwanted effect regarding the wieving properties for the transmissive parts.

Also according to the present invention, the birefringent optical layer is patterned so that the retardation of the birefringent material in a domain 8 covering a reflective subpixel 4 of a pixel is different from the retardation of a birefringent material in the domain(s) 9 covering the transmissive subpixel(s) 5 of said pixel.

In cases where the retardation is patterned, the retardation preferably differs at least 100 nm in the normal viewing direction between a domain covering reflective subpixel and a domain covering a corresponding transmissive subpixel.

According to the present invention, at least one, but optionally two or all three of the tilt, the orientation and the retardation is patterned.

As used herein, the tilt, or θ, refers to the angle between the director of the birefringent molecule and the surface of the birefringent material.

As used herein, orientation, or φ, refers to the angle between the director of the birefringent molecules and a predefined direction in the horizontal plane (e.g. the transmission axis of one of the polarizers).

As used herein, retardation, or dΔn, refers to a phase difference between the ordinary component and the extraordinary component that appears when light travels through a birefringent material. The retardation is dependent of the refraction indicies in the material and the thickness of the material.

As used herein, the director of a birefringent material refers to a thought axis through a symmetry axis of a birefringent material. For rodlike molecules, the director is aligned parallel to the molecule's long axis. For discotic molecules, the director is parallel to the normal of the plane of the discotic part of the molecules.

The above described patterning allows the optical layer to be adapted independently for the transmissive and the reflective part of the transflective display.

For color display applications, where multiple pixels of different colour represents a single picture element (e.g. in RGB-displays, where each picture element is represented by a red, a green and a blue pixel), the birefringence additionally may be adapted independently for each colour.

Preferably, this optimization aims to improve the viewing angle dependence for the display. Improved viewing angle dependence, as used herein, refers to that high contrast can be obtained through a wider range of viewing angles, i.e. the angle between the normal of the surface of the display and the direction from which the display is viewed. Improved viewing angle dependence also refers to that the display through a wider range of viewing angles can be viewed upon without encountering gray scale inversion (GSI).

In case the optical layer 7 is divided into two or more sublayers, these layers interact optically to give the appropriate optical properties of the combined layers.

Examples of patterning of the tilt, orientation and/or the retardation is given below in preferred embodiments.

The material is preferably formed from polymerisable liquid crystals, wherein the tilt, orientation and/or cholesteric pitch may be changed by subjecting the mixture to an external influence.

For the manufacture of the patterned optical layer 7, said mixture is preferably applied and aligned on a substrate. In some embodiments, the substrate is coated with an alignment layer such as a multidomain rubbed or photo-aligned polyimide-film or other suitable alignment layers known to those skilled in the art. The alignment may provide a patterning of the orientation of the liquid crystal molecules.

In other embodiments, an external field, such as a electric or magnetic field, is used to align the liquid crystal molecules.

Preferably, the mixture comprising liquid crystal material is such that the tilt, orientation and/or the cholesteric pitch of the liquid crystal molecules may be altered by exposing the mixture to different influences. Such influences comprises heat, pressure, surrounding atmosphere, changes of composition in the mixture, light irradiation, radioactive irradiation (α, β and/or γ-radiation) and combinations thereof. For example, the order of liquid crystal materials generally changes with the temperature, from crystalline at low temperatures, via smectic and nematic, to isotropic (no birefringence) at high temperatures.

In preferred embodiments of the present invention the mixture may comprise a convertible compound that upon conversion changes the tilt, orientation and/or cholesteric pitch of the liquid crystal molecules. Such convertible compounds include isomerisable chiral compounds possessing helical twisting power. Upon conversion, the chiral compounds may change the cholesteric pitch of the liquid crystal mixture, for instance by decreasing the cholesteric pitch, or by increasing the cholesteric pitch of liquid crystal mixture, for instance to infinity (i.e. turning a cholesteric liquid crystal material into a nematic liquid crystal material). Such isomerisable chiral compounds include derivatives of menthone as described in WO 00/34808.

In some instances, the mixture comprises volatile components that under certain conditions (temperature, atmosphere, pressure, etc) may evaporate from the mixture into the surrounding atmosphere, and which evaporation leads to a change in the tilt of the liquid crystal molecules.

The liquid crystal molecules in the photo-polymerisable mixture may be photo-alignable such that the tilt and/or orientation of the liquid crystal molecules may be aligned in a certain configuration by irradiating the molecules with light of a certain polarization.

When the mixture is irradiated with light of certain wavelengths, depending on the absorption band of the photoinitiator but preferably UV-light, the polymerisable compound polymerizes, thus fixing the liquid crystal molecules in the orientation, tilt and/or cholesteric pitch that they exhibited before the polymerization. In most instances, the liquid crystal molecules are photo-polymerisable, (polymerisable liquid crystals) and the mixture contains photoiniatiators to start the polymerization upon irradiation. The mixture may also comprises non liquid crystalline polymerisable compounds, not polymerisable liquid crystalline compounds.

To produce a patterned optical layer, the mixture is first aligned on a substrate. Then the mixture may be subjected to a first influence to arrange the liquid crystal molecules in a first configuration. In the case said first influence comprises a step of irradiation of the mixture to obtain a change of the configuration, this may optionally be performed through a mask, thus only subjecting parts of the mixture to said influence. Subsequently, the mixture is irradiated with light through a mask yielding polymerization in the irradiated parts of the mixture, thus fixing the liquid crystal molecules in the irradiated areas in a configuration exhibiting a first birefringence. Subsequently, the mixture may be subjected to a second influence, optionally through a mask, whereby the liquid crystal molecules in areas subjected to the second influence arranges in a second configuration, where after at least the areas subjected to the second influence are irradiated with light, yielding polymerization also in these areas, thus fixing the liquid crystal molecules in a configuration exhibiting a second birefringence. Thus, an optical layer with patterned birefringence is obtained.

For colour display applications, the manufacturing of the optical layer may be performed in a multi-step process, wherein the birefringence is independently patterned for each colour.

Preferably, domains covering reflective subpixels are formed into λ/4-retarders or wide band λ/4-retarders. WO 03/01972 discloses that patterned λ/4-retarders renders improved contrast ratio and viewing angle dependence to the reflective part of a transflective LCD.

A λ/4-retarder (quarter wave)is a retarder in which the retardation corresponds to ¼ of the wavelength of the light. A wideband λ/4-retarder is a retarder that functions as a retarder for a wide band of wavelengths. If not otherwise mentioned, the term λ/4-retarders also includes wide band λ/4-retarders.

Several configurations of birefringent materials for forming λ/4-retarders and wide band λ/4-retarders are known in the art for different types of birefringent material, such as for rodlike liquid crystal material with positive birefringence (see e.g. Yoshimi et al, SID'02 Digest, p 862 (1992); Belyaev et al, Eurodisplay 2002, p 449 (2002) and Uchiyama et al, IDW'00, p 402 (2000)), and for discotic liquid crystal materials with negative birefringence. Several examples of configurations for λ/4-retarders are given below in preferred embodiments of the present invention.

Preferably, the birefringent material in the domains covering transmissive subpixels functions as a viewing angle compensator.

Suitable arrangements of the molecules as viewing angle compensator depends on the material used for the optical layer, as well as on the type of LC-effect used in the LCD. The aim for the viewing angle compensator is to at least partially avoid contrast degradation and/or gray scale inversion at oblique viewing angles.

Preferably the viewing angle compensators compensate for the ellipticity of the light induced by the LC-layer. For instance, in a normally-white LCD (NW-LCD), the compensation is especially preferred in the driven (black) state, where unwanted leakage of light gives a reduced contrast. Several configurations for viewing angle compensators are known in the art for different types of birefiingent materials, such as for rodlike liquid crystal material with positive birefringence (P Yeh and C Gu, “Optics of liquid crystal displays”, chapter 9, Wiley, New York, 1999), and for discotic liquid crystal materials with negative birefringence (see, eg U.S. Pat. No. 5,583,679 and U.S. Pat. No. 5,990,997). Several examples of viewing angle compensation configurations are given below in preferred embodiments.

### PREFERRED EMBODIMENTS

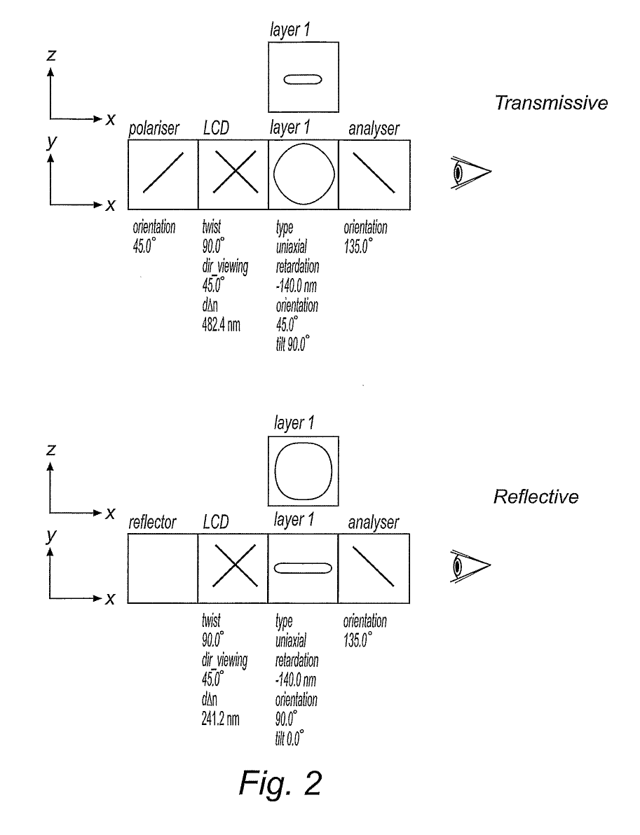

In a first preferred embodiment of the present invention, as shown in FIG. 2, the optical layer (layer 1 in the figure) comprises negatively birefringent discotic molecules. In the transmissive part of the layer, the tilt, θ, of the discotic molecules is 90°, i.e. the director of the optical axis is perpendicular to the surface of the optical layer and the orientation, φ, is approximately 45°

In the reflective part of the layer, the tilt, θ, of the discotic molecules are 0°, and the orientation, φ, is 0°.

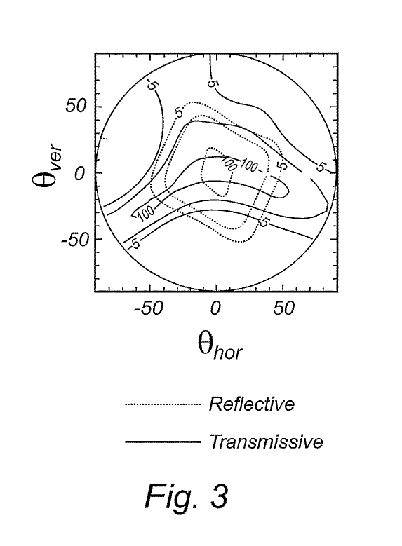

Results from this first embodiment, in form of a contrast vs. viewing angle plat, is shown in FIG. 3.

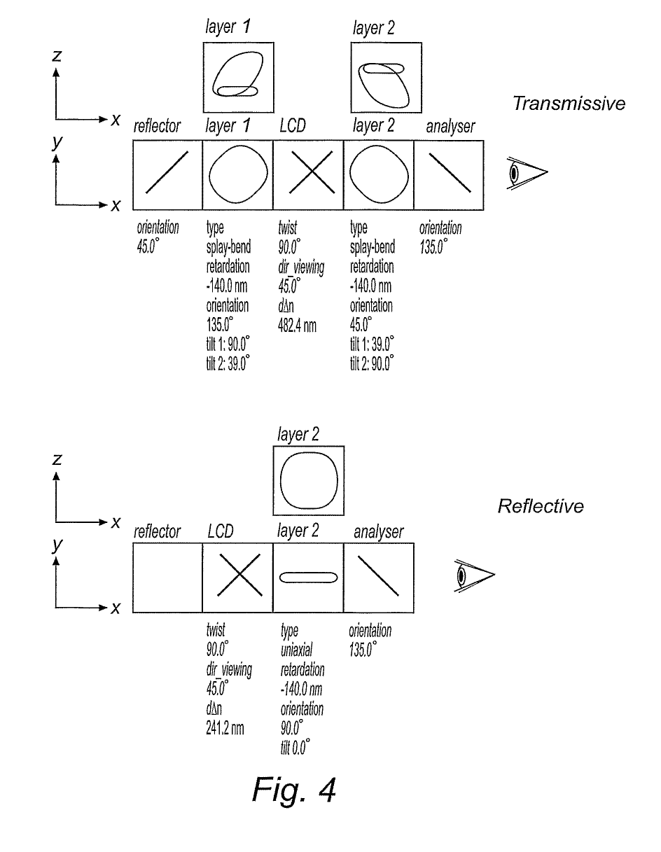

In a second preferred embodiment of the present invention, as shown in FIG. 4, the optical layer according to the present invention (layer 2 in the figure) comprises negatively birefringent discotic molecules. In the transmissive part of the layer, the tilt, θ, totally, essentially continuously, increases with an increase of distance from the surface of the optical layer facing the back substrate. This is a so-called “splay bent” conformation. The tilt, θ, increases from 39° at the rear surface of the layer (the surface facing the LC-layer) to 90° at the front surface.

In the reflective part of the optical layer, the tilt, θ, is 0° and the orientation, φ, is 90°.

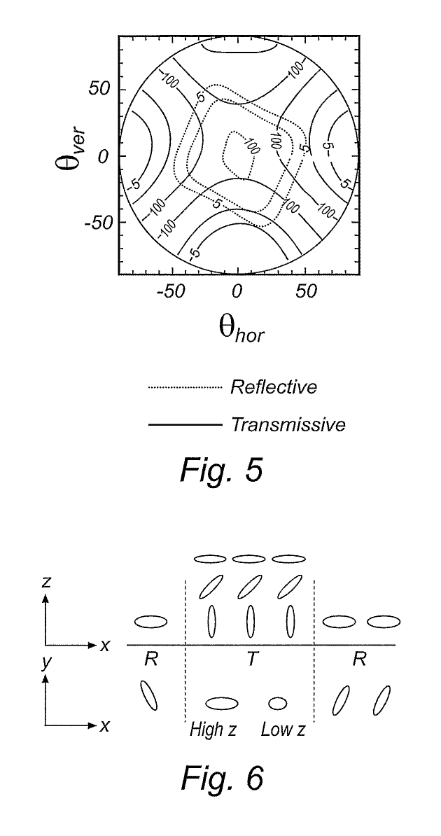

Results from this second embodiment, in form of a contrast vs. viewing angle plat, is shown in FIG. 5.

In a third preferred embodiment of the present invention, as shown in FIG. 6, the optical layer comprises rodlike molecules with positive birefringence. In the transmissive part, the molecules are in a “splay bend” conformation, wherein the tilt either totally, preferably continuously, increases or with an increase of distance from the rear surface of the layer. Preferably, the tilt ranges from 0 to 90°, more preferably from 5 to 85°. The orientation in the transmissive part of the optical layer differs approximately 45° from the orientation in the reflective subpixel, thus, the orientation may be 0° or 90°.

In the reflective part of the optical layer, the tilt, θ, is 0°, and the orientation, φ, is 45°.

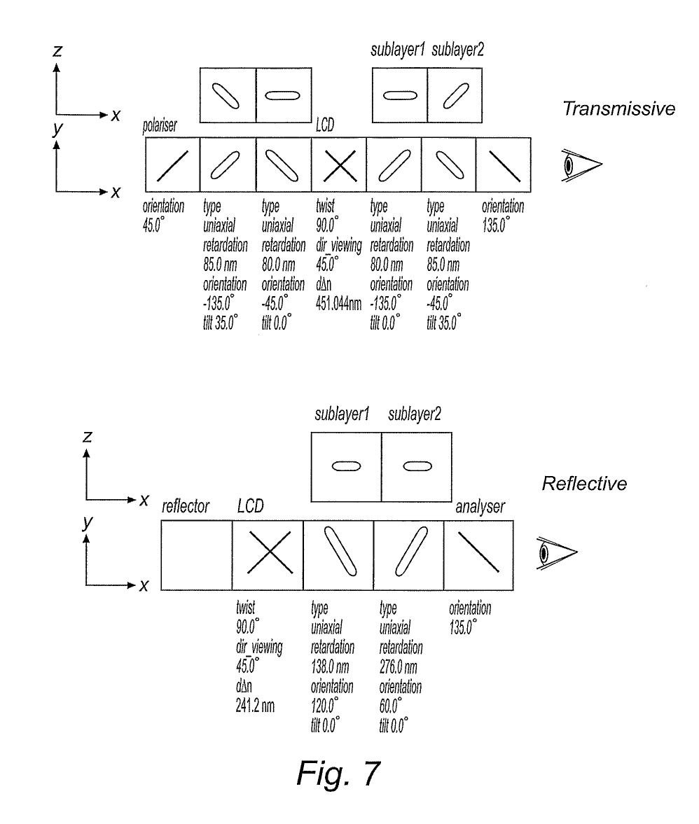

FIG. 7 schematically shows a stack representation of preferred embodiment of a transflective LCD display comprising a patterned optical layer according to the present invention. As is seen from the figure, the optical layer comprises two separate sublayers (sublayers 1 and 2) of patterned optical material, a first sublayer facing the LC-layer and a second sublayer facing the user, both sublayers comprising rodlike molecules with positive birefringence. The two positively birefringement layers in combination gives a total negative birefringement. In the first layer, in the transmissive part, the tilt is 0° and the orientation is −135°, and in the reflective part, the tilt is 0° and the orientation is 120°.

In the second layer, in the transmissive part, the tilt is 35° and the orientation is −45°, and in the reflective part, the tilt is 0° and the orientation is 60°.

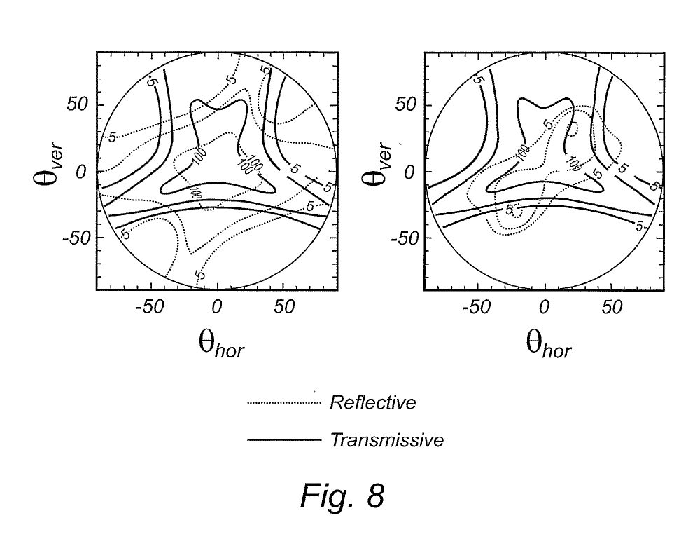

Results by using a optical layer according to this embodiment is shown in FIG. 8, wherein results for the present patterned layer is shown in the left graph, and corresponding results for a non-patterned layer, wherein also the domains covering transmissive subpixels have the properties of the domains covering reflective subpixels as described above.

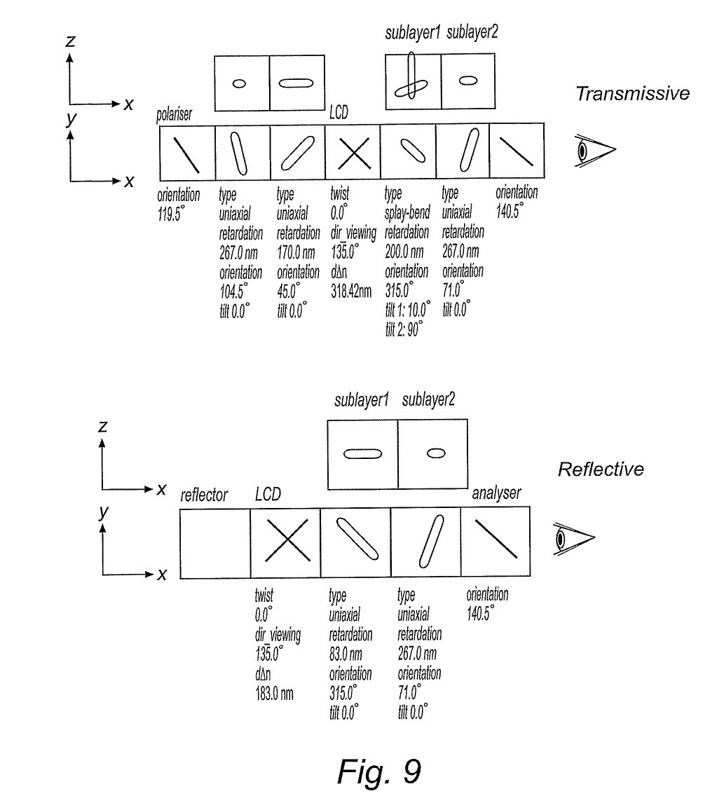

FIG. 9 schematically shows a stack representation of a preferred embodiment of a LCD display comprising a patterned optical layer according to the present invention. As is seen from the figure, the optical layer comprises two separate sublayers (sublayers 1 and 2) of birefringent material, a first sublayer facing the LC-layer and a second sublayer facing the user, both sublayers comprising rodlike molecules with positive birefringence. The two positively birefringement sublayers in combination gives a total negative birefringement. In the first sublayer, in the transmissive part, the tilt forms a splay bend deformation wherein the tilt at the side facing the interior of the display is 10° and the tilt at the side facing the user is 90°, with an essentially continuous increase of the tilt over the layer. The orientation in the transmissive part of this layer is 315°. In the reflective part, the tilt is 0° and the orientation is 315°.

The second sublayer is not patterned and covers both reflective and transmissive subpixels, and in this sublayer, the tilt is 0° and the orientation is 267°. However, the optical properties of the combined sublayers 1 and 2 are patterned.

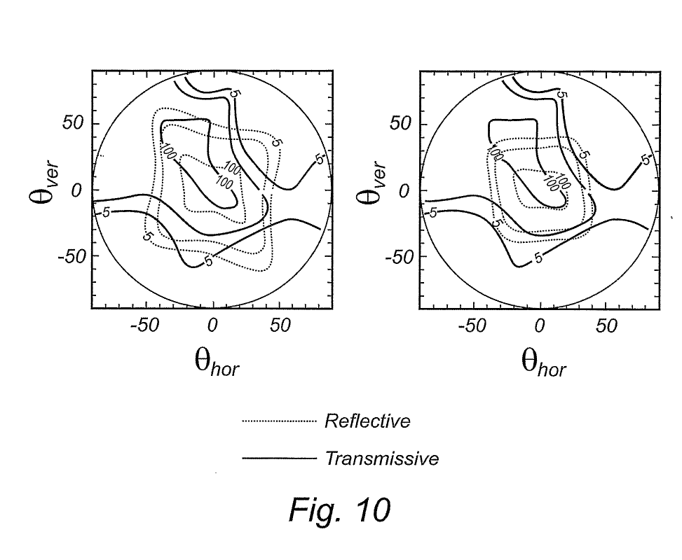

Results by using a optical layer according to this embodiment is shown in FIG. 10, wherein results for the present patterned layer is shown in the left graph, and corresponding results for a non-patterned layer, wherein also the domains covering transmissive subpixels have the properties of the domains covering reflective subpixels as described above.

It should be noted that the described preferred embodiments and the following experiments only are used for illustrative purposes only, and is not intended to limit the scope of the invention.

### EXAMPLES

### Example 1

A substrate is provided with an alignment layer (rubbed polyimide or photo-alignment layer). A mixture of reactive LC materials comprising a quantity of (reactive) isomerizable chiral compound is spincoated on top of the alignment layer providing a layer of cholesterically ordered material with a cholesteric pitch smaller than or equal to 300 nm. The mixture may further contain reactive non-chiral LC's, non-isomerizable chiral compounds and photo-initiators. The layer can be irradiated according to a desired pattern so that the isomerizable chiral compound is converted and the cholesteric pitch is increased to infinity in the irradiated regions (layer has become nematic). This can be accomplished if the helical twisting power (HTP) of the isomerizable chiral compound is zero upon conversion or if the product of HTP times concentration of the isomerizable compound after conversion is equal but opposite of sign to the product of HTP and concentration of a non-isomerizable chiral compound present in the mixture. Finally, the patterned layer is polymerized and/or crosslinked via photopolymerization or electron beam polymerization.

The opposite process is also possible: After spincoating a uniaxial retardation layer is formed (HTP×conc of isomerizable chiral compound before conversion is equal to HTP×concentrattion of non-isomerizable chiral compound). Upon irradiation through a mask the HTP of the isomerizable compound changes and the irradiated regions transform in cholesterically ordered material with a cholestric pitch of 300 nm or smaller.

### Example 2

In this second method a reactive chiral LC compound or mixture of (chiral) reactive LC materials is used that exhibit both a chiral nematic (cholesteric) phase as well as a smectic-A phase. The material or mixture is spincoated onto a substrate provided with an alignment layer. At low temperatures the material will be in the smectic-A phase and in this way a uniaxial retardation layer is formed after spin coating. Irradiating the layer in accordance with a desired pattern will result in photo-polymerization in the irradiated areas. Subsequently, the temperature is raised above the transition temperature from the smectic-A phase to the cholesteric phase. In the non-polymerized areas the order will change from smectic to cholesteric, while the smectic order will be preserved in the polymerized areas. A flood exposure at elevated temperatures will freeze the cholesteric order through photo polymerization and yield a patterned optical layer.

### Example 3

A dual domain photoaligned alignment film is prepared according to, for example, the methods described by limura et al, J Photopolym Sci Technol 8, p 257, (1995) and Schadt et al, Nature 381, p 212, (1996) or by other methods known to those skilled in the art, wherein the director orientation is determined by the polarization of the UV light used during a two step UV exposure. A liquid crystal mixture RMM34 (available from Merck) is spincoated on top of the dual domain photo-alignment film, for instance an LPP 265 CP layer. Thus the planar alignment of the reactive LC monomers is achieved. The optical layer is partially crosslinked by a UV mask exposure in a nitrogen atmosphere to freeze in the desired planar state (tilt 0°) required for the λ/4 retardation in the reflective part of the pixel. The optical layer is subsequently annealed at an elevated temperature for about 10 min. During the anneal step the volatile surfactant in the liquid crystal mixture evaporated, leading to a splayed configuration in the non-crosslinked parts. The splay can be varied by the anneal time. Finally, the order of the splayed configuration is also fixed by an UV exposure for 5 min in a nitrogen atmosphere (20 mW/cm²).

### Example 4

A dual domain photoaligned alignment film is prepared as in the latter embodiment. A liquid crystal mixture comprising 1,4-phenylene-bis-[4-(6-acryloxy)methyl-oxy]benzoate (0.5 g) (a reactive liquid crystal molecule, available from Merck), 4-(6acryloylxyhexyloxy)-2-methyl-phenyl-4-(6-acryloyloxyhexyloxy)cinnamate (0.5 g), Irgacure 651 (0.05 g) (a photo-initiator) and RM502 (0.05 g) (a surfactant) in xylene (4.0 g) is spincoated on top of the dual domain alignment layer being for instance an LPP 265 CP layer. The order parameter in the liquid crystal mixture is partially decreased by illuminating the mixture through a mask with UV-light at 365 nm (HPA lamp, 4 mW/cm²) in air. The cinnamates in the mixture isomerise leading to a decrease in anisotropy of molecular polarization and a splay configuration. Finally the obtained order is permanently fixed by UV exposure for 5 min in a nitrogen atmosphere.

1. A transflective liquid crystal display comprising a plurality of pixels, a liquid crystal layer (3) and an optical layer (7) comprising a birefringent material, said pixels being divided into at least one transmissive subpixel (5) and at least one reflective subpixel (4), and
said optical layer (7) being patterned into domains (8, 9), each covering at least part of a reflective subpixel (4) or at least part of a transmissive subpixel (5), the birefringent material in a first domain (8) covering a reflective subpixel (4) of a pixel having a first birefringence and the birefringent material in a second domain (9) covering a transmissive subpixel (5) of said pixel having a second birefringence,
wherein the first and second birefringence are different from each other and adapted independently to improve the viewing angle dependence for the reflective and transmissive subpixels respectively.

2. A transflective liquid crystal display according to claim 1, wherein the birefringent material of the optical layer (7) in the first domain (8) and in the second domain (9) are made from the same material.

3. A transflective liquid crystal display according to claim 1, wherein the birefringent material is a material with positive birefringence.

4. A transflective liquid crystal display according claim 1, wherein the birefringent material is a material with negative birefringence.

5. A transflective liquid crystal display according to claim 1, wherein the tilt of the optical axis of the birefringent material in the optical layer (7) in the first domain (8) is different from the tilt of the optical axis of the birefringent material in the optical layer in the second domain (9).

6. A transflective liquid crystal display according to claim 1, wherein the direction of the optical axis of the birefringent material in the optical layer (7) in the first domain (8) is different from the direction of the optical axis of the birefringent material in the optical layer in the second domain (9).

7. A transflective liquid crystal display according to claim 1, wherein the retardation of the birefringent material in the optical layer (7) in the first domain (8) is different from the retardation of the birefringent material in the optical layer in the second domain (9).

8. A transflective liquid crystal display according to claim 5, wherein the tilt of the optical axis of said birefringent material in the optical layer (7) in either the first or the second domain varies over a thickness of the optical layer.

9. A transflective liquid crystal display according to claim 1, wherein the birefringent material of the optical layer in the domains covering transmissive and/or reflective subpixels is a cholesterically ordered material.

10. A transflective liquid crystal display according to claim 9, wherein a cholesteric pitch of the birefringent material in the optical layer in a first domain (8) is different from a cholesteric pitch of the birefringent material in the optical layer in the second domain (9).

11. A transflective liquid crystal display according to claim 1, wherein said optical layer (7) comprises at least two sublayers, at least one of said sublayers being patterned into domains.

12. A transflective liquid crystal display according to claim 1, wherein the optical layer in the second domain (9) comprises a viewing angle compensator.

13. A transflective liquid crystal display according to claim 1, wherein the optical layer in the first domain (8) comprises a quarter wave retarder.

14. A transflective liquid crystal display according to claim 13, wherein the retardation of said λ/4-retarders is in the range of 100 to 200 nm.

15. A transflective liquid crystal display comprising a plurality of pixels, a liquid crystal layer (3) and an optical layer (7) comprising a birefringent material, said pixels being divided into at least one transmissive subpixel (5) and at least one reflective subpixel (4), and
said optical layer (7) being patterned into domains (8, 9), each covering at least part of a reflective subpixel (4) or at least part of a transmissive subpixel (5), the birefringent material in a first domain (8) covering a reflective subpixel (4) of a pixel having a first birefringence and the birefringent material in a second domain (9) covering a transmissive subpixel (5) of said pixel having a second birefringence,
wherein the first and second birefringence are different from each other and adapted independently to improve the viewing angle dependence for the reflective and transmissive subpixels respectively, wherein the optical layer (7) is obtainable by a method according to claim 16.

16. Method for the manufacture of a patterned optical layer, said method comprising:
providing a photo-polymerisable mixture having a liquid crystalline phase; aligning said mixture;
performing a first irradiation of the mixture under a first reaction condition, to polymerize a first domain of photo-polymerisable mixture in a first configuration exhibiting a first birefringence;
performing a second irradiation of the mixture under a second reaction condition to polymerize a second domain of the photo-polymerisable mixture in a second configuration exhibiting a second birefringence.

17. A method according to claim 15, wherein said aligning is performed by photo-alignment or by alignment on a rubbed alignment film.

18. A method according to claim 16, further comprising a converting step, in which a convertible compound comprised in said photo-polymerisable mixture is converted, thereby changing the tilt of the liquid crystal molecules and/or the helical twist and/or the retardation of the mixture.

19. A method according to claim 16, further comprising an evaporation step, in which a volatile compound comprised in the photo-polymerisable mixture evaporates from the mixture, thereby changing the tilt of the liquid crystal molecules.

20. A method according to claim 16, further comprising a photo-alignment step, in which photo-alignable liquid crystal molecules are irradiated, thereby changing the tilt orientation of said photo-alignable liquid crystal molecules of the liquid crystalline mixture.

21. A method according to claim 16, wherein the temperature at the first reaction condition is different from the temperature at the second reaction condition.

22. A method according to claim 16, wherein the atmosphere at the first reaction condition is different from the atmosphere at the second reaction condition.
